(19) United States
(12) Patent Application Publication
(10) Pub. No.: US 2011/0036735 A1
(43) Pub. Date: Feb. 17, 2011

(54) TOOL BOX WITH REINFORCING STRUCTURE

(76) Inventor: Yao-Lin Cho, Taichung County (TW)

Correspondence Address: Chien-Hui Su, P. O. Box 70-121 Taichung, Taichung City, 40899, TW

(21) Appl. No.: 12/539,619

(22) Filed: Aug. 12, 2009

(51) Int. Cl. B25H 3/02; B65D 6/34

(52) U.S. Cl. 206/349; 220/646; 220/694

(57) ABSTRACT

A tool box with reinforcing structure includes a tool box having at least one connecting section disposed thereon, and at least one protection member engaged with the at least one connecting section. The at least one protection member moulded by extruded aluminium, such that the at least one protection member is tailorable for adapting to suit different standards of tool boxes to provide for protecting, decorating, and reinforcing the tool box.

### BACKGROUND OF THE INVENTION

1. Field of the Invention

The present invention relates to a tool box with reinforcing structure, and more particularly to a tool box which is decorated and reinforced by at least one protection member molded by extruded aluminium.

2. Description of Related Art

A conventional tool box with reinforcing structure comprises a box, a bottom for the box having a first flange disposed parallel to the side wall of the box. An angle member is disposed in the box. The angle member has a second flange engaged between the first flanges of the bottom and the side wall of the box. The side wall has a third flange disposed below the bottom and approximately parallel to the bottom. A bar is transversely inserted between the third flange and the bottom to reinforce the bottom and to reinforce the third flange. A band surrounds the box. A plurality of securing elements is extended through the band and through the wall of the box, wherein the band reinforces the side walls of the box.

However, the prior art is suffered from several disadvantages. The tool box only has the band surrounding the side wall and the bar engaged with the flanges disposed on side walls and the bottom for reinforcing the bottom and the side walls. A reinforce structure of the conventional tool box is not strong enough such that the box may be fractured or broken on edges or surfaces easily. In addition, the box does not have any element provided for reinforcing corners thereof. Therefore, the tool box does not have enough structural strength to carry the weight of heavy tools and to prevent from breaking.

The present invention has arisen to mitigate and/or obviate the disadvantages of the conventional tool box with reinforcing structure.

### SUMMARY OF THE INVENTION

The main objective of the present invention is to provide an improved tool box with reinforcing structure.

To achieve the objective, the tool box with reinforcing structure in accordance with the present invention includes a tool box having at least one connecting section disposed thereon, and at least one protection member mounted on the at least one connecting section. The at least one protection member moulded by extruded aluminium, such that the at least one protection member is tailorable for adapting to suit different standards of tool boxes to provide for protecting, decorating, and reinforcing the tool box

The at least one connecting section includes a plurality of first connecting sections respectively disposed on edges of the tool box. Each of the first connecting sections has a groove defined therein along the edge. The groove extends through one end of the edge to form an opening. An inner peripheries of the groove is gradually tapered from a bottom thereof, such that the groove having a dove-tail structure. The at least one connecting section includes a plurality of second connecting sections respectively disposed on corners of the tool box. Each of the second connecting sections has a hole defined therein.

The at least one protection member includes a plurality of edge protectors. Each of the edge protectors has a longitudinal rib extended from one side thereof. The longitudinal rib is in a shape corresponding to the groove. The longitudinal rib slides into the groove from the opening for being correspondingly engaged with the groove. The at least one protector member includes a plurality of corner protectors. Each of the corner protectors has a first protrusion extended from one side thereof for inserting into the hole.

Accordingly, the edge protectors are respectively engaged with the first connecting sections for reinforcing the edges of the tool box. The corner protectors are respectively engaged with the second connecting sections for reinforcing the corners of the tool box.

In accordance with a second aspect of the present invention, the at least one connecting sections includes a plurality of third connecting sections disposed on surfaces of the tool box. Each of the third connecting sections has at least one recess defined therein. The at least one protector member includes a plurality of panel plates. Each of the panel plates has at least one second protrusion extended from one side thereof for corresponding engaging with the at least one recess, wherein the panel plates are respectively engaged with the third connecting sections for decorating and reinforcing the surfaces of the tool box.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a preferred embodiment of a tool box with reinforcing structure in accordance with the present invention;

FIG. 2 is a partial perspective view of an edge protector of the tool box with reinforcing structure in accordance with the present invention;

FIGS. 3-4 are partial enlarged perspective views of the assembly of a first connecting section and the edge protector of the tool box with reinforcing structure in accordance with the present invention;

FIGS. 5-6 are enlarged operational plane views of the assembly of a second connecting section and a corner protector of the tool box with reinforcing structure in accordance with the present invention;

FIG. 7 is an assembled perspective view of the preferred embodiment of the tool box with reinforcing structure in accordance with the present invention;

FIG. 8 is an exploded perspective view of a second embodiment of the tool box with reinforcing structure in accordance with the present invention; and

FIG. 9 is an exploded perspective view of a third embodiment of the tool box with reinforcing structure in accordance with the present invention.

### DETAILED DESCRIPTION OF THE INVENTION

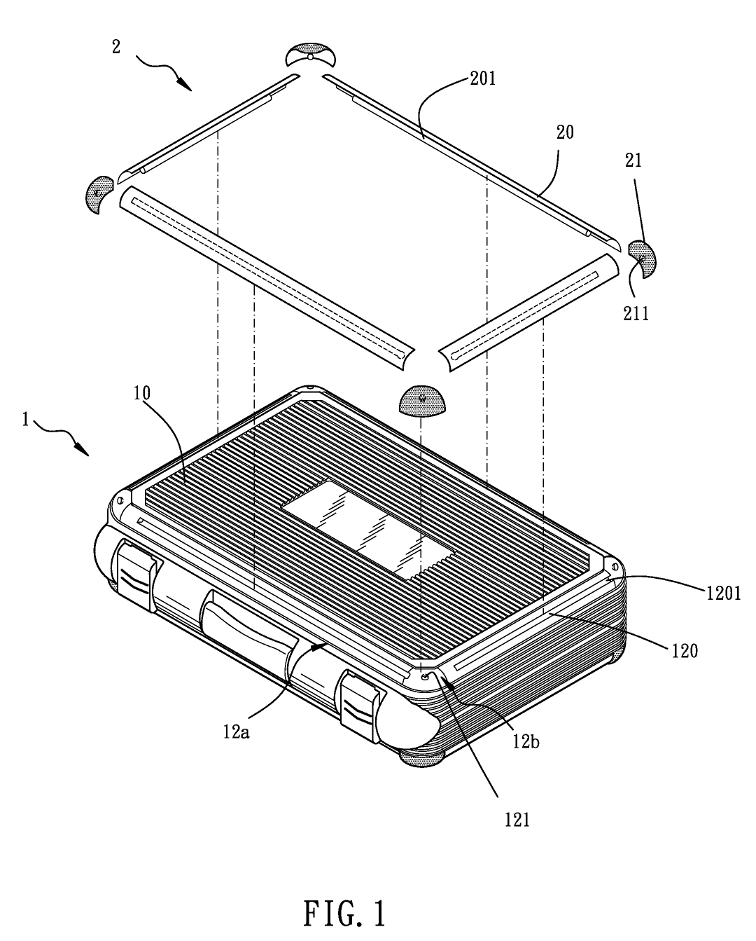

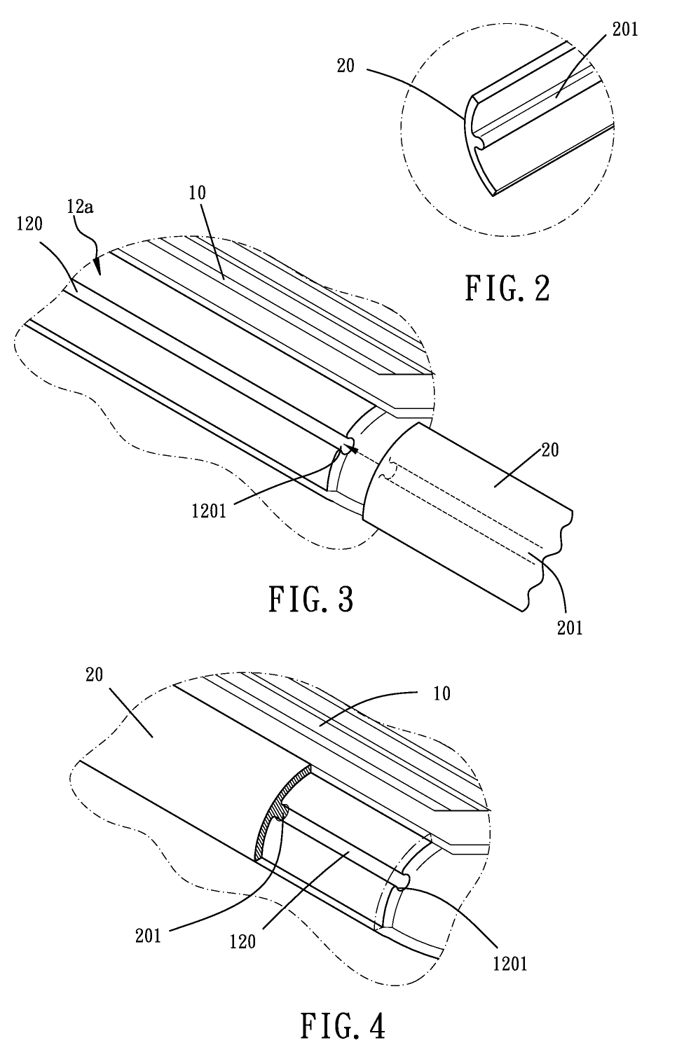

Referring to the drawings and initially to FIGS. 1-7, a tool box with reinforcing structure in accordance with a preferred embodiment of the present invention comprises a tool box (1) having at least one connecting section (12) disposed thereon and at least one protection member (2) mounted on the at least one connecting section (12).

The at least one connecting section (12) includes four first connecting sections (12a) respectively disposed on four edges of an outer surface (10) of the tool box (1). Each of the four first connecting sections (12a) has a groove (120) defined therein and parallel to the edge. One end of the groove (120) extends through one end of the edge to form an opening (1201). An inner periphery of the groove (120) is gradually tapered from a bottom thereof, such that the groove (120) has a dove-tail structure. The at least one connecting section (12) includes four second connecting sections (12b) respectively disposed on four corners of the outer surface (10) of the tool box (1). Each of the four second connecting sections (12b) has a hole (121) defined in the centre thereof. The four first connecting sections (12a) are in a convexly arc shape. Each of the four second connecting sections (12b) uncovers the opening (1201) of the groove (120) on each of the four first connecting sections (12a).

The at least one protection member (2) includes four edge protectors (20) being in a shape to respectively cover the four first connecting sections (12a). Each of the four edge protectors (20) has a longitudinal rib (201) extended from one side thereof. The longitudinal rib (201) is in a shape corresponding to the groove (120). Therefore, as shown in FIGS. 3-4, the longitudinal rib (201) is correspondingly inserted into the opening (1201) of the groove (120) and slides into the groove (120) for being engaged with the groove (120), wherein the four edge protectors (20) are respectively engaged with the four first connecting sections (12a) for reinforcing the four edges of the tool box (1).

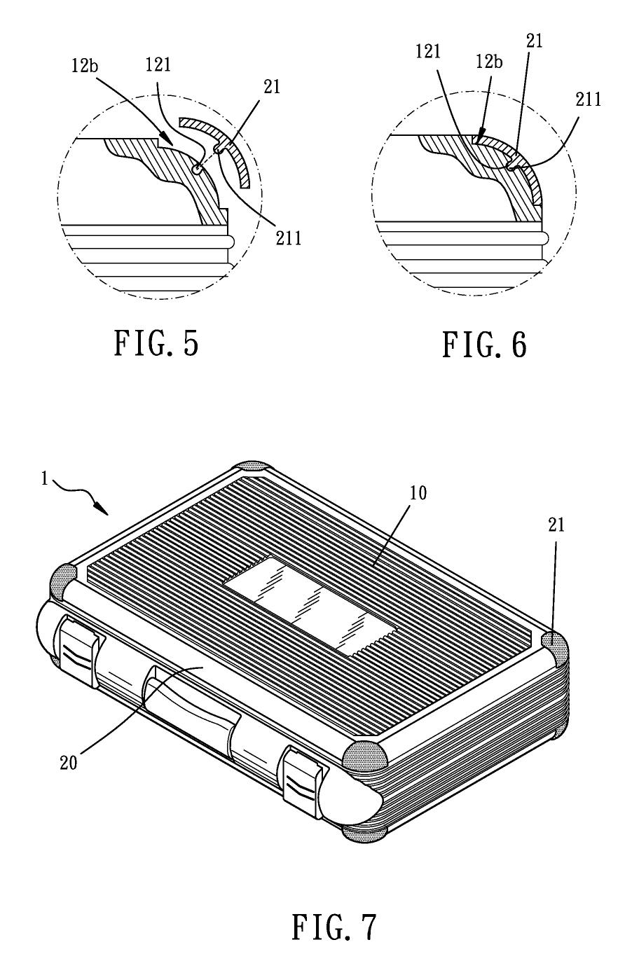

The at least one protection member (2) includes four corner protectors (21) being in a shape to respectively cover the four second connecting portions (12b) of the tool box (1). As shown in FIGS. 5-6, each of the four corner protectors (21) has a first protrusion (211) extended from one side thereof for correspondingly inserting into the hole (121) on each of the four second connecting sections (12b), wherein the four corner protectors (21) are respectively engaged with the four second connecting sections (12b) for reinforcing the corners of the tool box (1).

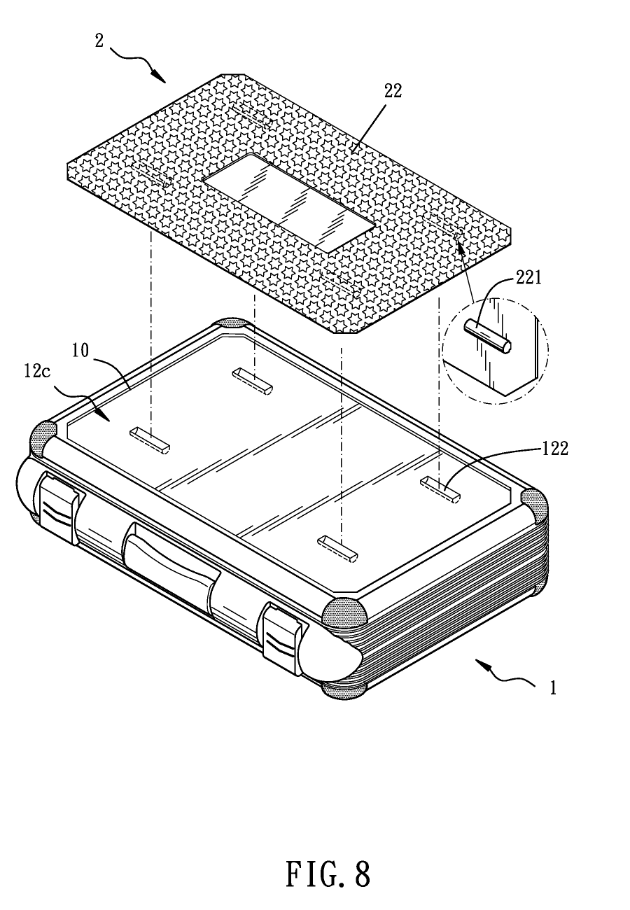

With reference to FIG. 8, a second embodiment of a tool box with reinforcing structure according to the present invention is illustrated. The elements and effects of the second embodiment which are the same with the preferred embodiment are not described, only the differences are described. The at least one connecting section (12) includes a third connecting section (12c) disposed on an outer surface (10) of the tool box (1). The third connecting section (12c) has a hollow structure and has four recesses (122) symmetrically defined therein. The at least one protector member (2) includes a panel plate (22) being in a shape to cover the third connecting section (12c). The panel plate (22) has one side disposed a decorative pattern or decorative symbols thereon. The other side of the panel plate (22) has four second protrusions (221) extended therefrom, such that the four second protrusions (221) are respectively engaged with the four recesses (122) for decorating and reinforcing the outer top surface (10) of the tool box (1).

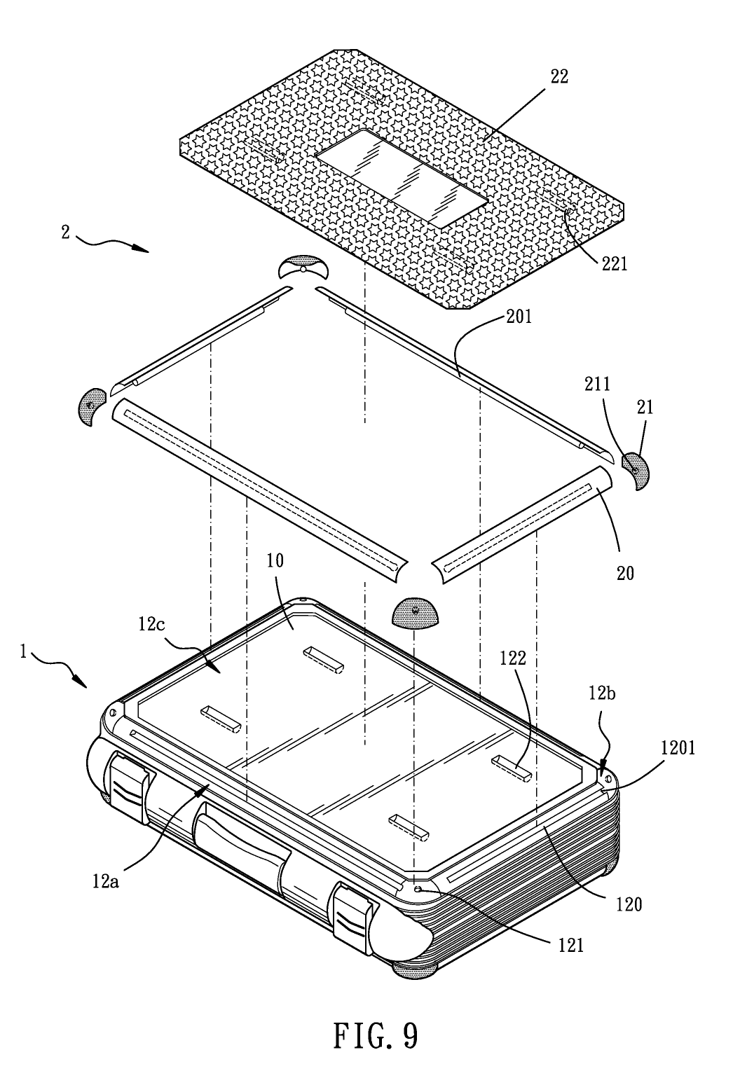

With reference to FIG. 9, a third embodiment of a tool box with reinforcing structure according to the present invention is illustrated. The elements and effects of the third embodiment which are the same with the preferred embodiment and the second embodiment are not described, only the differences are described. In this embodiment, the at least one connecting section (12) includes four first connecting sections (12a) respectively disposed on four edges of an outer surface (10) of the tool box (1), four second connecting sections (12b) respectively disposed on four corners of the outer surface (10) of the tool box (1), and a third connecting section (12c) disposed on the outer surface (10) of the tool box (1). The at least one protection member (2) includes four edge protectors (20) respectively engaged with the four first connecting section (12a), four corner protectors (21) respectively engaged with the four second connecting sections (12b), and a panel plate (22) engaged with the third connecting section (12c).

Consequently, the at least one protection member (2) is securely engaged with the at least one connecting section (12) to provide for reinforcing, decorating, and protecting the tool box (1).

Moreover, the at least one protection member (2) is moulded by extruded aluminium, such that the at least one protection member (2) is tailorable for adapting to suit different standards of tool boxes. Accordingly, the at least one protection member (2) provides for decorating and reinforcing the tool boxes and for lowering a productive cost. The assembly of the at least one protection member (2) is easy and time saving.

Although the invention has been explained in relation to its preferred embodiment, it is to be understood that many other possible modifications and variations can be made without departing from the spirit and scope of the invention as hereinafter claimed.

1. A tool box with reinforcing structure comprising:
a tool box having at least one connecting section disposed thereon, the at least one connecting section including a plurality of first connecting sections respectively disposed on edges of an outer surface of the tool box, each of the first connecting sections having a groove defined therein along the edge, the groove extending through one end of the edge to form an opening, the at least one connecting section including a plurality of second connecting sections respectively disposed on corners of the outer surface of the tool box, each of the second connecting sections having a hole defined therein, each second connecting section having a depth from the outer surface deeper than that of each first connecting section, such that each second connecting section uncovers the opening of the corresponding groove; and
at least one protection member mounted on the at least one connecting section, the at least one protection member including a plurality of edge protectors, each edge protector being plate-shaped, each of the edge protectors having a longitudinal rib extended from one side thereof, the longitudinal rib sliding into the groove from the opening for being correspondingly engaged with the groove, the at least one protector member including a plurality of corner protectors, each of the corner protectors having a first protrusion extended from one side thereof for inserting into the hole, the at least one protection member moulded by extruded aluminium to provide for decorating and reinforcing the tool box;
wherein when assembling, the edge protectors are respectively engaged with the first connecting sections and the corner protectors are respectively engaged with the second connecting sections for reinforcing the edges and corners of the tool box, each corner protector blocking the opening of the corresponding groove to prevent the corresponding edge protector from sliding out the groove, the at least one protection member being tailorable for adapting to suit different standards of tool boxes.

2. (canceled)

3. (canceled)

4. The tool box with reinforcing structure as claimed in claim 1, wherein an inner peripheries of the groove is gradually tapered from a bottom thereof such that the groove having a dove-tail structure, the longitudinal rib being in a shape corresponding to the groove.

5. The tool box with reinforcing structure as claimed in claim 1, wherein the at least one connecting sections includes a plurality of third connecting sections disposed on surfaces of the tool box, each of the third connecting sections having at least one recess defined therein, the at least one protector member including a plurality of panel plates, each of the panel plates having at least one second protrusion extended from one side thereof;
wherein the at least one second protrusion of each of the panel plates is correspondingly engaged with the at least one recess of each of the at least one third connecting section for decorating and reinforcing the surfaces of the tool box.

6. The tool box with reinforcing structure as claimed in claim 1, wherein each first connecting section has a bottom surface in a convexly arc shape and each edge protector is correspondingly arc plate-shaped for respectively and engagedly covering the corresponding first connecting section.
